(19) United States
(12) Patent Application Publication
(10) Pub. No.: US 2007/0045170 A1
(43) Pub. Date: Mar. 1, 2007

(54) Filter cartridge

(76) Inventors: Andreas Wawrla, Widnau (CH); Klaus Zucholl, Mannheim (DE)

Correspondence Address: William D Breneman;Breneman & Georges, 3150 Commonwealth Avenue, Alexandria, VA, 22305, US

(21) Appl. No.: 10/563,945

(22) PCT Filed: Jul. 9, 2004
(86) PCT No.: PCT/EP04/07605

§ 371 Date: May 18, 2006

(30) Foreign Application Priority Data
Jul. 10, 2003 (DE) 103 31 402.4
Dec. 17, 2003 (DE) 103 59 443.4

(51) Int. Cl. B01D 35/28

(52) U.S. Cl. 210/435

(57) ABSTRACT

The invention relates to an environmentally friendly water filter cartridge (10) for use in the water tank (1) of a household machine such as a beverage dispenser or the like that is easy to dispose of after use. To this end, the invention provides that a discharge line (7) running outside the filter housing (12) is provided with the connecting elements for connecting to a suction line of the household machine.

The invention relates to a filter cartridge according to the preamble of claim 1, as well as to a water tank for a household machine with such a filter cartridge, along with a corresponding household machine.

Filter cartridges have become known in beverage dispensers that are used directly in the water tank of the beverage dispenser. These filter cartridges are provided with water inlet openings on the floor, through which the water enters, and then passes the filter material up-current. The filtered water is subsequently routed downwardly in a central penstock inside the filter cartridge, where the filter cartridge or penstock is connected with a suction port of the machine.

The object of the invention is to propose an environmentally friendly filter cartridge that can be disposed of as easily as possible.

This object is achieved based on a water filter cartridge of the kind mentioned at the outset by the characterizing features of Claim 1.

The measures cited in the subclaims enable advantageous embodiments and further developments of the invention.

Consequently, a water filter cartridge according to the invention is characterized in that a discharge line running outside the filter casing is provided with a connection to a suction line of the household machine.

This measure eliminates the need for a central penstock. The filter casing design can be simplified, which facilitates the filling and emptying process. The less complicated filter structure reduces the consumption of material for building purposes, thereby easing the subsequent disposal of spent filter cartridges. The smoother material separation capability also simplifies disposal by producing waste cleanly separated by grade.

If a pourable filter material is provided, both sides of the filter material must have a water-permeable separating wall, e.g., in the form of a sieve. Such a separating wall is also significantly easier to design without a central penstock.

In addition, a coupling is advantageously provided between the discharge line and filter casing. In this way, the discharge line running outside the filter casing can be retained when changing out the filter cartridge, thereby further reducing the material outlay for the insert to be replaced. In turn, the repeated decrease in the quantity of material to be changed facilitates disposal.

In addition, this also simplifies filter assembly, since the connecting line for the discharge line remaining on the household machine can at least be made visible to the user, and even directly accessible, depending on the model.

In a special embodiment of the invention, the discharge line is designed as a penstock in the water tank. One advantage to this is that the filter cartridge can be used in conventional beverage dispensers, in which a water outlet is provided in the floor area of the water tank. As mentioned above, the penstock is here preferably fabricated as a part separate from the filter cartridge that is inserted into the water tank, and remains there even when changing the filter. The filter cartridge is detachably coupled with the stationary penstock, wherein the connection can lie over or under the water level. The need for any major sealing measures is eliminated, since this coupling point between the penstock and filter casing is arranged inside the water tank, as is the case with the coupling point between the penstock and suction port. As indicated above, the filter cartridge itself can be fabricated as a simple casing that can easily be filled with filter material and again emptied, and hence enables disposal of cleanly sorted waste.

In addition, such a casing can be cleaned and refilled, so that only the filter material itself accrues as waste.

In another embodiment of the invention, the discharge line is outside the water storage tank. The advantage to this is that the water tank used need no longer have an opening on the floor. In addition, such a discharge line could be securely linked directly to the corresponding suction line of the household machine, in particular of a coffee dispenser. This discharge line can here be provided outside the water tank as a penstock, or make a transition directly into the suction line of the machine, e.g., of a coffee dispenser, without a drop path.

In this case, the channel for the discharge line could lie above the water level, so that, while sealing measures might still be required to make the suction line airtight, the water is collected in the water tank in case of an undesired leakage of water. In this case, a corresponding passageway would be favorable in the upper region of the water tank, making it possible to remove the water tank with or without a filter cartridge if the cover is lifted while avoiding any adverse impact on the part of the discharge line.

If the connection exists outside the water tank, the discharge line would additionally not have to be designed as a penstock, but rather could be routed directly to corresponding machine components at a suitable height.

In another preferred embodiment of the invention, a penstock is formed by means of a separating wall in the water tank. Such a separating wall is easy to set up while fabricating the water tank, which often has a flat shape for various reasons, in particular in beverage dispensers. In this case, the discharge line is very easy to design. The upper side of the penstock separated from the remainder of the water tank by a separating wall must then be provided with corresponding coupling elements for hooking up the filter cartridge.

A penstock permanently integrated into the water tank, e.g., a penstock formed by means of such a separating wall or a penstock of the filter cartridge separately secured inside the water tank is provided with a sealable opening in the floor area of the water tank. This makes it possible to operate the corresponding machine without the filter cartridge inserted by opening this connection opening. Arranging this connection opening near the floor makes it possible to empty the water tank at least to the level of this opening even without a filter cartridge. Seal actuation can here be coupled with the filter insertion, or take place separately, either manually or automatically, via the household machine.

In an advantageous further development of this embodiment, the process of sealing or opening this connection opening is linked with the insertion or removal of a water filter cartridge. For example, this can be initiated by a corresponding sliding mechanism, if necessary fitted with sealing elements, which is actuated by closing the coupling between the penstock and filter cartridge.

Twisting the penstock to establish the coupling with the filter cartridge would also be conceivable, so as to simultaneously seal a connection opening near the floor. Additionally conceivable is a special further development of the invention, in which the filter cartridge is positively attached to the separate penstock, sealing a corresponding opening via the outer wall of the filter casing in the process.

Given a separating wall in the water tank for setting up a penstock, for example, a filter cartridge could be passed in a corresponding guide of the separating wall and inserted up to the connection opening.

As already mentioned above, a coupling is provided between the discharge line and suction line in a special embodiment of the invention. On the one hand, the advantage to this is that a filter cartridge according to the invention can also be used in existing household machines, in particular coffee dispensers, by placing the discharge line in the water tank and connecting it with the floor port for the suction line. In addition, such a discharge line can be easily exchanged in the event of a defect.

In addition, the discharge line is simultaneously designed as an adapter piece for adjusting a filter cartridge to the respective machine type in an advantageous further development of this embodiment. As a result, the same filter cartridge can be used in different machine types, or, vice versa, different filter cartridges can be used in the exact same machine, wherein only the corresponding adapter piece needs to be inserted, which in this case also incorporates the discharge line of the filter cartridge.

A filter cartridge according to the invention can advantageously also be provided with a display indicating when the filter must be replaced. Such a display can be equipped with a saturation sensor, for example, which indicates when filter capacity has been exhausted. This point in time can also be determined by means of a flow meter or timer.

An exemplary embodiment of the invention is shown in the drawing, and will be explained in greater detail below based on the figures.

Shown in detail on:

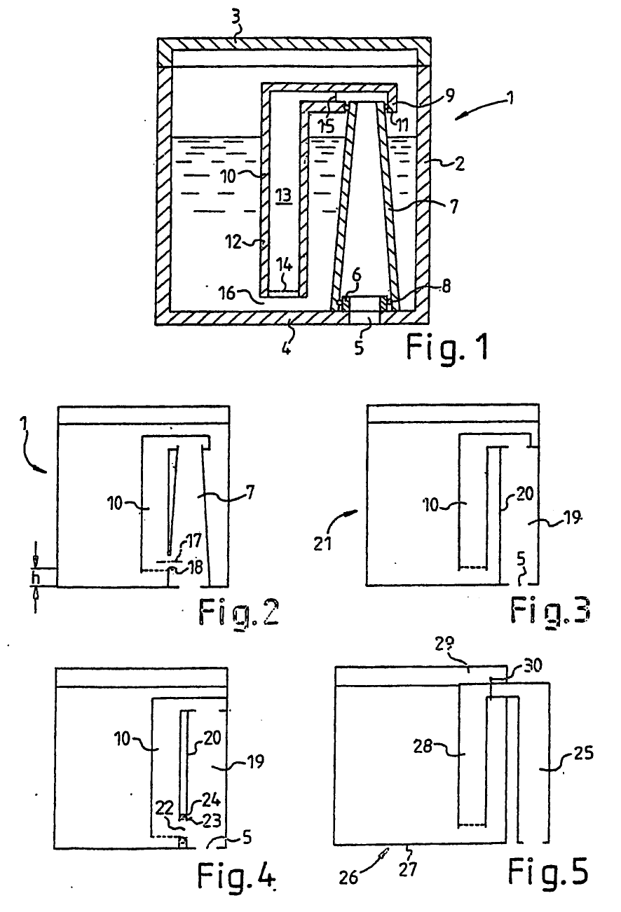

FIG. 1 is a schematic sectional view of a water tank with filter cartridge according to the invention;

FIG. 2 is a schematic view of another embodiment;

FIG. 3 is a view according to FIG. 2 of a third embodiment of the invention;

FIG. 4 is a view according to FIG. 2 and 3 of a fourth embodiment of the invention;

FIG. 5 is a view according to FIG. 2 to 4 of a fifth embodiment of the invention;

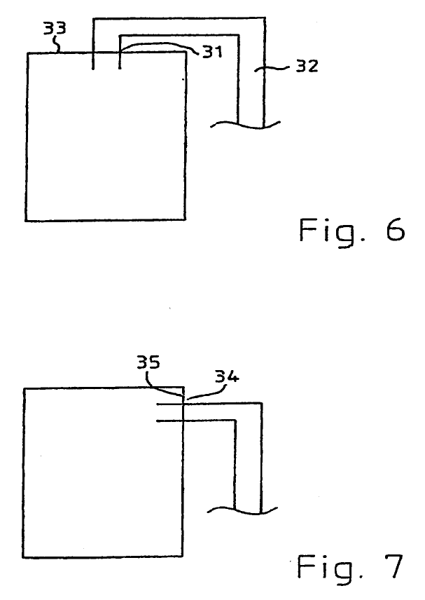

FIG. 6 is a schematic view of a sixth embodiment, and

FIG. 7 is a schematic view of another modified embodiment.

FIG. 1 shows the water tank 1 of a household machine, e.g., a beverage dispenser or coffee dispenser. The water tank 1 encompasses a container 2, which can be sealed by means of a cover 3. The floor 4 of the water tank 1 or container 2 incorporates a suction opening 5 for a hookup (not shown in any greater detail) to the corresponding household machine, e.g., a beverage dispenser, like a coffee dispenser or the like.

The inside of the suction opening 5 has an annular collar 6, onto which a penstock 7 is attached. A sealing ring 8 is provided in the embodiment shown to tightly connect the penstock 7.

A plug-in element 9 of a filter cartridge 10 is inserted on the top of the penstock 7, and in turn sealed by means of a sealing ring 11. The filter cartridge 10 comprises a tubular filter casing 12, which has a filter chamber 13 sealed by two sieves 14, 15. The filter chamber 13 accommodates the required filter material. As shown on FIG. 1, the filter casing 12 is hence open below, so that the gap 16 between the filter casing 12 and container floor 4 forms the inlet into the filter chamber 13.

As soon as water is drawn in at the suction opening 5, it flows upwardly through the filter chamber 13 to the upper region of the penstock 7.

Once the filter cartridge 10 has been spent, it along with the plug-in element 9 is removed from the penstock 7 and replaced. The penstock 7 can here remain in the water tank 1.

In the embodiment shown, the penstock 7 is easily designed as an adapter piece that can be inserted between various kinds of connecting elements.

FIG. 2 shows another embodiment that essentially corresponds to the one depicted on FIG. 1. The difference here is that the filter cartridge is form-fit to the penstock 7 in the lower region. This makes it possible to establish a through opening 17 denoted by the line between the interior of the container 2 and interior of the penstock 7, which is sealed by the wall area 18 of the filter cartridge 10 with the filter cartridge inserted. In this way, the water tank 1 can be emptied to a level h at which the opening 17 lies even with the filter cartridge 10 removed, meaning that the corresponding household machine can also be operated without a filter cartridge.

The embodiment according to FIG. 3 again essentially reflects the aforementioned exemplary embodiments, wherein the penstock 19 is now formed by means of a separating wall 20 in the edge area of the water tank 21. This embodiment does not require an adapter corresponding to the penstock 7 between the filter cartridge 10 and penstock 19.

FIG. 4 shows an embodiment according to FIG. 3, wherein the filter cartridge 10 now runs tightly along the separating wall 20, so that an opening 22 near the floor in the separating wall 20 can now be sealed by the corresponding wall area 23 of the filter cartridge 10. A sealing element 24 has here been drawn in to denote the capability of implementing additional sealing measures.

This embodiment also enables operation of the corresponding household machine without a filter cartridge 10, wherein the water can again flow through the opening 22 with the filter cartridge removed.

By contrast, FIG. 5 shows a differently configured embodiment of the invention. The penstock 25 is here located outside the water tank 26, which hence has no opening in the container floor 27.

The filter cartridge 28 is coupled in the upper region of the water tank 26. Corresponding coupling elements 30 are only indicated on FIG. 5. For example, a plug-in coupling can be provided in this location.

Arranging the coupling elements 30 in the upper area of the water tank 26 makes it possible to take the filter cartridge off the penstock 25, and then remove the water tank 26. If the mount for the water tank 26 is designed correctly, the water tank 26 can conceivably also be removed from below with the cover 29 opened, without removing the filter cartridge 28 from the penstock 25.

The penstock 25 can here be connected as a fixed component of the corresponding machine, e.g., a beverage dispenser, or again be provided as a separate part. Given a separate design, the penstock 25 can be used as an adapter piece for adjusting a specific filter cartridge 28 to a plurality of household machines or hooking various filter cartridges 28 to a specific household machine.

FIG. 6 and 7 schematically show two additional embodiments of the invention. FIG. 6 depicts an embodiment in which the coupling 31 between the penstock 32 and filter casing is arranged in the cover 33. By contrast, the coupling 34 in the embodiment according to FIG. 7 is secured in the area of the lateral wall 35.

### REFERENCE LIST

1 Water tank
2 Container
3 Cover
4 Floor
5 Suction opening
6 Annular collar
7 Penstock
8 Sealing ring
9 Plug-in element
10 Filter cartridge
11 Sealing ring
12 Filter casing
13 Filter chamber
14 Sieve
15 Sieve
16 Gap
17 Opening
18 Wall area
19 Penstock
20 Separating wall
21 Water tank
22 Opening
23 Wall area
24 Sealing element
25 Penstock
26 Water tank
27 Floor
28 Filter cartridge
29 Cover
30 Coupling element
31 Coupling
32 Penstock
33 Cover
34 Coupling
35 Lateral wall

What is claimed is:

1. A water filter cartridge for insertion in the water tank of a household machine, such as a beverage dispenser, in particular a coffee dispenser, a steam cleaner or the like, with a filter casing, in which a filter material is arranged between a lower inlet and upper outlet, wherein the casing in the floor area has one or more water inlet openings, characterized in that a discharge line (7) running outside the filter casing (2) is provided with connecting elements for coupling to a suction line (5) of the household machine.

2. A water filter cartridge according to claim 1, characterized in that a coupling (9, 11) is provided between the discharge line (7) and the filter casing (12).

3. A water tank for a household machine, such as a beverage dispenser, in particular a coffee dispenser, a steam cleaner or the like, and a water filter cartridge according to claim 1 or 2, characterized in that the discharge line is designed as a penstock (7) inside the water tank (1).

4. A water tank according to claim 3, characterized in that the discharge line is routed laterally out of the water tank (1).

5. A water tank according to one of the aforementioned claims 3 or 4, characterized in that the discharge line (25) is designed as a penstock outside the water tank (26).

6. A water tank according to one of the aforementioned claims 3 to 5, characterized in that the discharge line (19) is designed as a penstock through a separating wall inside the water tank (21).

7. A water tank according to one of the aforementioned claims 3 to 6, characterized in that a sealable connection opening (17) is provided in the floor area of the water tank (1) in the discharge line (7) designed as a penstock.

8. A water tank according to one of the aforementioned claims 3 to 7, characterized in that the connection opening can be sealed using a water filter cartridge.

9. A household machine, such as a beverage dispenser, in particular a coffee dispenser, a steam cleaner or the like, with a water tank (1) according to one of claims 3 to 8, and a water filter cartridge (10) according to one of claims 1 or 2, characterized in that coupling elements (6, 8) are provided for connecting the discharge line (7) of the filter cartridge with the suction line (5) of the household machine.

10. A household machine according to claim 9, characterized in that the discharge line (7) is designed as an adapter piece between the filter cartridge (10) and coupling elements (6, 8) of the suction line (5) of the household machine.
